(19) United States
(12) Patent Application Publication
(10) Pub. No.: US 2003/0107146 A1
(43) Pub. Date: Jun. 12, 2003

(54) Method of producing optical element forming die, optical element forming die unit and optical element forming die

(75) Inventors: Shigeru Hosoe, Tokyo (JP); Hiroshi Nagoya, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 10/300,871

(22) Filed: Nov. 21, 2002

(30) Foreign Application Priority Data
Nov. 26, 2001 (JP) 359838/2001
Jan. 25, 2002 (JP) 017122/2002

(51) Int. Cl. C03B 1/00

(52) U.S. Cl. 264/81; 65/374.13; 65/374.15; 264/682; 264/678

(57) ABSTRACT

A method of producing an optical element forming die to form an optical element by pressing a glass material softened with heat, including a first process of producing a primary processed product having a volume resistance value Z (0<Z≦1 (Ω·cm) by sintering ceramic powders; and a second process of forming the optical element forming die by processing the primary processed product.

### BACKGROUND OF THE INVENTION

The present invention relates to an optical element forming die employing a ceramic material, a manufacturing method of the optical element forming die, a manufacturing method of an optical element and an optical element forming die unit.

Heretofore, an optical element made of glass such as a glass lens has been manufactured through a grinding process which requires much time, and therefore, it has been used in a relatively expensive optical equipment in many cases. In these days, however, simplification of a lens Item and lightweight of a lens portion are presently attained simultaneously, by using an aspheric glass lens which is excellent in optical characteristics, in an inexpensive optical equipment. Since rapid processing and mass production are difficult for manufacture of the aspheric glass lens if the conventional grinding process is used, there has come to use the so-called glass molding method wherein an optical glass material is heated, pressed and formed, after it is fed as it is or after it is heated in advance, in a space between internal end faces (optical surface transfer faces) of a pair of optical element forming dies to manufacture a glass lens.

In this case, since the optical surface transfer face of the optical element forming die is transferred as it is to the optical surface of the glass lens in the course of heating and pressing, characteristics of the optical element forming die for which the glass molding method is used need to include that the optical surface transfer face can be processed to a mirror-finished surface which can be used for optical application, haze on the optical surface transfer face caused by oxidation does not appear even at high temperature, fusion is hardly caused when touching melted glass material, and mechanical strength which stands pressure and shock of heating and pressing.

As a material for the optical element forming die of this kind, there are considered, for example, cemented carbon or ceramic. In this case, the cemented carbon has a merit that machine work for it is generally easy, compared with ceramic, however, it has problems that chemical reaction is caused when it touches high temperature glass material that is heated and melted, and tungsten carbide representing a major component is oxidized by oxygen or water vapor mixed in a molding atmosphere. Due to the characteristics of the cemented carbon that its heat resistance and chemical reactivity are inferior, when the cemented carbon is used as a material of the die for transfer-forming an optical surface of an optical element, there has been a fear that an extremely serious problem such as haze on the optical surface transfer face that transfers an optical surface, or scratches on an accurate fitting portion for regulating the eccentricity of the optical surface transfer face, for example, is caused. For these problems, it is possible to take actions, to a certain extent, by keeping the molding atmosphere to be highly air-tight, or by restoring the optical surface transfer face frequently. However, there is caused a separate problem that facilities are complicated and maintenance is troublesome and time-consuming. On the contrary, it is possible to avoid problems of haze on the optical surface transfer face which is caused when cemented carbon is used as a material of the die and of scratches on an accurate fitting portion. However, since the material itself for ceramic is extremely hard in general, machining of ceramic is not easy and processing for a long time is required to obtain a mirror-finished surface of the optical surface transfer face, which causes a problem that manufacture cost rises sharply. There is also a problem that it is extremely difficult to conduct machine work for complicated forms such as making deep holes for inserting therein a thermocouple or a heating heater for measuring temperatures of the optical element forming die. There is further a problem that electroplating processing cannot be conducted because ceramic is non-conductive.

### SUMMARY OF THE INVENTION

The invention has been achieved in view of the problems stated above, and its object is to provide a low cost optical element forming die which can be processed easily though ceramic material is used, a manufacturing method for the optical element forming die, a manufacturing method for an optical element and an optical element forming die unit.

### BRIEF DESCRIPTION OF THE DRAWINGS

FIG. 1 is a diagram showing a manufacturing process for an optical element forming die.

FIG. 2 is a diagram showing a manufacturing process for an optical element forming die.

FIG. 3 is a diagram showing a manufacturing process for an optical element forming die.

FIG. 4 is a diagram showing a manufacturing process for an optical element forming die.

FIG. 5 is a diagram showing a manufacturing process for an optical element forming die.

FIG. 6 is a diagram showing a manufacturing process for an optical element forming die.

FIG. 7 is a sectional view of a die set including an optical element forming die for forming an optical element.

### DETAILED DESCRIPTION OF THE PREFERRED EMBODIMENT

First, the structure of the invention attaining the aforesaid object will be explained.

The optical element forming die in Item 1 is one for forming an optical element by applying pressure to heated and softened glass material, wherein at least a part of the optical element forming die is formed by using conductive ceramic, and volume resistance value Z of the conductive ceramic satisfies the following expression.

0<Z≦1 [Ω·cm] (1)

Now, conductive ceramic will be explained. Silicon carbide includes β type silicon carbide of face centered cubic crystal (close-packed structure) and α type silicon carbide of other crystal structure. In this case, α type silicon carbide is non-conductive, but β type silicon carbide is known to have conductivity of about 10-1000 Ω·cm. β type silicon carbide is manufactured by CVD method, but depending on a type of the CVD method and on the then manufacturing conditions, fine particles of β type silicon carbide containing carbons can be made. For example, when silicon tetrachloride gas and methane are made by plasma CVD to react on each other, β type silicon carbide which is mostly pure can be made through the following chemical formula (I), but when ethylene gas is introduced in place of methane, free carbon is generated through chemical formula (II), and β type silicon carbide which is carbon-rich is made.

If there is placed, in CVD apparatus, no base material to which the deposited silicon carbide is to be stuck, in particular, SiC and C are coagulated and deposited each other through reaction by plasma, and fall in the apparatus as minute powder, thus, powder can be obtained easily.

SiCl₄+CH₄→SiC+4HCl Chemical formula (I)

SiCl₄+C₂H₄→SiC+C+4HCl Chemical formula (II)

It was found that ceramic material obtained by mixing an appropriate amount of β type silicon carbide powder with α type silicon carbide powder and by sintering them is much more excellent than material containing only β type silicon carbide in terms of conductivity. For example, if the volume resistance value thereof satisfies Expression (1), it is possible to conduct processing which has been impossible to apply to conventional ceramic materials. Namely, in the case of the conventional ceramic material, it has been impossible to conduct electro-discharge machining because of non-conductivity of the ceramic material, and it has been necessary to cut the material by applying mechanical processing for a long time such as grinding work by a grindstone. However, in the case of the conductive ceramic material whose volume resistance value Z satisfies the Expression (1), mass production of optical element forming dies can be carried out at low cost, because the electro-discharge machining can easily be conducted in a short time. Incidentally, as conductive ceramic, titanium carbide or titanium nitride can also be used in addition to the aforementioned silicon carbide, and the invention is not limited to them. For example, even in the case of the titanium carbide, conductive powder is obtained through the following chemical formula (III) in exactly the same way as in the silicon carbide, and therefore, bulk material of conductive ceramic can be obtained by mixing and sintering in the same way. However, a manufacturing method of conductive power like this is out of the scope of the invention.

TiCl₄+C₂H₄→TiC+C+4HCl Chemical formula (III)

Incidentally, “at least a part of the optical element forming die” means that it is not necessary to use conductive ceramic for all portions of the die if the conductive ceramic is used for a portion that requires, for example, electro-discharge machining or electroplating.

It was also found that β type silicon carbide (β-SiC) can be given conductivity depending on the size of its crystal particle, and there is relationship, on the whole, between resistivity Z (Ω·cm) and crystal particle diameter φc (nm).

Z=10 exp (φc−37)/2.5) (1)

Therefore, with respect to β type silicon carbide (β-SiC), if gas density and plasma power are adjusted in plasma CVD to make crystal particle of 37 nm or less to fall, it is possible to obtain powder having resistivity (0<Z≦1 Ω·cm) that makes electro-discharge machining to be possible, even when carbon C is not contained, and if this β type silicon carbide is subjected to high pressure sintering (hot press) independently or under mixture with α type silicon carbide (α-SiC), it is possible to obtain conductive ceramic (SiC) used in the invention.

Usually, β type silicon carbide is mixed with α type silicon carbide (α-SiC) while keeping balance between conductive effect by a size of a crystal particle of β type silicon carbide (β-SiC) and conductive effect by the aforesaid deposition of carbon C, to optimize a prescription of material and to conduct high pressure sintering, thus, it is possible to obtain desired SiC sinter that is highly conductive.

The optical element forming die in Item 2 is one for forming an optical element, wherein a tapered surface is provided on a surface for pressing the optical element forming die, and the optical element forming die can be positioned in the course of molding when the tapered surface is pressed, and thereby, its positioning accuracy can be improved, and maintainability can be improved including that the optical element forming die can be removed easily. In particular, it is preferable that the tapered surface is a surface on the optical element forming die that hits a press member when mounting the optical element forming die on the press member that moves in the pressing direction for press molding, in a glass mold optical element molding machine for example. Depending on a shape of a taper on the tapered surface, the moving member and the optical element forming die can be fitted easily each other, and thereby, shifting and tilting for the center axis of an optical surface transfer face can be regulated strictly. There also is an advantage that the optical element forming die and the press member can be disassembled easily. As stated above, the tapered surface provided on the optical element forming die offers many structural merits that decentering for the upper and lower dies can be regulated accurately without providing a precise fitting portion with a frame type which causes scratches easily on the optical element forming die, and the optical element forming die an be mounted on and dismounted from the molding machine easily for maintenance. However, the tapered surface has never been introduced in an optical element forming die for mass production use. As a reason for this, there is given a problem that the tapered surface needs to be ground for formation of its form with a fine cut in an order of μm for a long time by using an expensive diamond whetstone and a highly rigid machining apparatus, because ceramic material is extremely hard, and cost of its processing occupies 20% or more of the total cost for forming the shape of the optical element forming die. When the conductive ceramic related to the invention is used, 90% or more of processing for the tapered surface can be conducted by electro-discharge machining on an unmanned basis, and only finishing touch that determines accuracy of the tapered surface needs the grinding work finally, thus, cost of the processing and processing time for the tapered surface are reduced sharply to a fraction of those in the past. Therefore, it is possible to introduce an outer form having a tapered surface to the optical element forming die even for a use of optical element forming dies in a large amount needed for mass production, thus, the aforementioned merits of the tapered surface can easily be enjoyed.

The optical element forming die in Item 3 is characterized in that a ceramic layer is formed on at least an optical surface transfer face for forming thereon an optical surface of an optical element and/or geometrical dimension reference plane transfer surface for forming thereon geometrical dimension reference plane of the optical element, by the use of CVD method. The CVD (Chemical Vapor Deposition) method is a method to make particles or a thin film through chemical reactions in a gas phase or on the surface of a base body, by supplying material gas of one or plural types of compounds containing constituent chemical element of materials from which a thin film or particles need to be prepared. In general, the CVD method has advantageous points that a film casting speed is high and close adhesion to a base body is excellent.

A ceramic layer formed by this CVD method is minute in terms of structure and can be subjected to optical mirror finish processing, and oxidation at high temperature hardly advances although its outermost layer is oxidized. Therefore, if the ceramic layer of this kind is applied to the optical surface transfer face, surface haze is not caused, and if the ceramic layer is used for the geometric dimension reference plane transfer surface, its dimensional accuracy is not worsened, which is an advantageous point, thus, an optical element forming die which is more accurate can be provided.

In the optical element forming die in Item 3, when the conductive ceramic and the ceramic layer contain silicon carbide as a component, character of fitting between the optical element forming die and the layer stated above is excellent, and it is possible to control troubles such as breaking and scaling of the layer caused in thermal expansion and shrinkage of the optical element forming die.

In the optical element forming die in Item 5, a protective layer for preventing fusion of glass and/or oxidation of the optical element forming die is provided on the optical surface transfer face and/or the geometric dimension reference plane transfer surface to cover the layered ceramic, and therefore, mold releasing character between glass material cooled down after molding and the optical surface transfer face and/or the geometric dimension reference plane transfer surface is enhanced, and quality deterioration of the molded optical element caused by fusion of glass material can be controlled. Since it is further possible to prevent oxidation even in the case of molding use under high temperature, it is possible to prevent deterioration phenomenon on the surface roughness caused by quality deterioration of glass material can be prevented.

Incidentally, when a layer of silicon carbide is heated, its outermost surface is oxidized to become silicon oxide. Since the progress of the silicon oxide to the inside of the layer is extremely slow, characteristics of a mirror finished surface as an optical surface transfer face are not damaged, but, silicon oxide is a primary component of glass silicate, and it basically has characteristics to be fused easily with glass material. Therefore, when heating the glass material for press molding, it has been conducted generally that a molding atmosphere is replaced with inert gas such as nitrogen gas so that oxygen in the air may not touch the optical element forming die. However, in glass molding, glass material and the optical element forming die reciprocate between an atmosphere in the air and a molding atmosphere in accordance with a molding cycle, oxidation on the surface of the optical element forming die by silicon carbide material cannot be avoided, because a component of the air (oxygen) cannot be removed from the molding atmosphere thoroughly. Therefore, when silicon carbide is used on the optical surface transfer face, it is effective to provide a protective layer to prevent fusion of glass material and to improve mold releasing character.

In the optical element forming die in Item 6, it is preferable that the aforementioned protective layer is a single layer or a multi-layer made of at least one material selected from carbon, diamond-like carbon, glass-like carbon, platinum alloy, titanium, titanium carbide, titanium nitride, chromium, chromium carbide, chromium nitride, boron nitride, silicon carbide and silicon nitride. For the protective layer, the optimum material may be selected from the aforementioned materials, by considering the strength of adhesion to an optical element forming die or characters of fusion with glass material to be used. Among the materials mentioned above, diamond-like carbon is especially preferable in terms of the mold releasing character and hardness, and a high frequency plasma CVD method, an ion beam evaporation method and a sputtering method are available as a layer making method. The high frequency plasma CVD method is effective on the point that the structure of processing apparatus is simple and a layer can be formed on a large area. A layer of hard carbon represented by diamond-like carbon has a merit that an optical element forming die can be recycled by repeating layer-removing and layer-forming by the use of the same processing apparatus, because a layer can be removed easily by oxygen plasma ashing.

The optical element forming die in Item 7 is characterized in that its temperature can be raised to the prescribed temperature. Namely, since the optical element forming die of the invention employs conductive ceramic, an electric current can be made to pass through the optical element forming die. In this case, if the temperature of the molding die is raised to the prescribed temperature by Joule heat based on that electric current, a heater for heating the optical element forming die is omissible, or the heater may be one having small heat capacity. Further, since a temperature of the optical surface transfer face or the geometrical dimension reference plane transfer surface itself is raised independently of heat conducted from a heater or other members, an electric current needed for temperature rise can be small in quantity, thus, small power can be realized, and yet, temperature rise on the plane is uniform. Thus, it is possible to prevent a deformation caused by local overheating and heat expansion in the course of molding, and thereby to attain highly accurate temperature control with neither overshoot nor ringing. Further, as a condition that glass material does not stick to an optical element forming die, it is important that a temperature of the die is lower than that of the glass material, which realizes that condition accurately on an excellent reproducibility basis.

In the optical element forming die in Item 8, it is possible to form a desired plated layer on the optical element forming die, because conductive ceramic is used, an electric current can be made to pass through the optical element forming die, and electric plating processing can be conducted accordingly. Since most of conductive ceramic, to say nothing of conventional non-conductive ceramic, are non-magnetic, high frequency induction heating cannot be used when heating and raising temperature for molding, if no action is taken for the conductive ceramic. Therefore, there has been no way but a method to heat the die indirectly by the heating method such as a heater or an infrared ray lamp and to raise temperatures. However, if a thick layer made of magnetic material of an iron type or a cobalt type is provided on the conductive ceramic by electric plating processing, this portion can be heated directly by high frequency heating. When the frequency is made to be high, in particular, induction electric current is concentrated on the object surface by skin effect, and the plated layer thus formed improves heating efficiency sharply. In addition, heat is conducted to the die from the plated layer highly efficiently, because the plated layer that is high-frequency-heated is in close contact completely with the conductive ceramic die, thus, heating which is almost direct heating and temperature rise are realized. By providing a thick metal plated layer on the surface of the optical element forming die made of conductive ceramic as stated above, a molding die alone can be selectively heated directly on a non-contact basis, and therefore, heating and temperature rise can be conducted at high speed with least energy, and molding can be conducted while keeping an optical surface to be of a long life, thus, there are generated great merits that cost of the die is lowered, a rate of operation of a molding machine is improved by reduction of die replacement frequency and die repairing takes less time. Further, a heater does not need to be housed in the die, and holes to be machined are only those for a thermocouple for monitoring die temperature, which makes processing for the die easy, and a connecting portion for wiring from the heating power supply which has been necessary when an electric current flows through the die is not needed, therefore, the number of parts related to the die is less, and replacement of die is extremely easy. A desired plated layer can be formed on the surface of the optical element forming die.

The manufacturing method of the optical element forming die in Item 9 is one for manufacturing an optical element forming die that forms an optical element by pressing heated and softened glass material having therein a first process to generate a primary processed article that is made of sintered ceramic powder and has volume resistance value Z (0<Z≦1 [Ω·cm] and a second process that forms the optical element forming die by processing the primary processed article, wherein a primary processed article having a form sintered easily and volume resistance value Z (0<Z≦1 [Ω·cm] can be formed easily by generating the primary processed article by sintering the ceramic powder in the first process, and optical element forming dies can be manufactured on a mass production basis because it is possible to conduct processing such as cutting an optical element forming die through technology of electro-discharge machining from the primary processed article generated in the second process. The primary processed article obtained by sintering the ceramic powder mentioned here is conductive silicon carbide which is manufactured in the process wherein super fine powder of silicon carbide having particle size of about 30 nm is generated by plasma CVD method, for example, and several percent of this one is added to silicon carbide power available on the market to be sintered, and the conductive silicon carbide thus manufactured may be either in a bulk shape (solid) after sintering or in a slightly shaped type. When a large amount of optical element forming dies are needed, if a large sintered body is manufactured in the aforesaid manner to be cut in a required size, man-hours for manufacturing can be shortened sharply.

In the manufacturing method of the optical element forming die in Item 10, a laminar primary processed article is generated through a hot press method in the first process. If the hot pressing (high pressure sintering method) is used, sintering is possible in an apparatus which is extremely simple with less auxiliary agent for sintering or without using it, thus, the primary processed article has high purity and high conductivity, resulting in advantages that strength is high and decline of strength at high temperature is less, which is preferable. Since the primary processed article representing a sintered body that is minute in terms of structure can be obtained, the present method is an effective method as a manufacturing method for an optical element forming die. However, as a sintering method, a reaction sintering method, a normal pressure sintering method, a gas-pressure sintering method and a hot isostatic pressure sintering method (HIP) can be used in addition to the hot pressing.

In the manufacturing method of the optical element forming die in Item 11, the second process stated above has a step for generating a secondary processed article by subdividing the primary processed article into a prescribed size through the electro-discharge machining. Since the primary processed article is made of conductive ceramic, it is possible to conduct the electro-discharge machining. For subdividing the primary processed article into the secondary processed article, there is considered a cutting work by means of a slicer which, however, has required an operator constantly for monitoring the state of a whetstone representing a cutting tool, chipping and damage. For this problem, it is possible to conduct cutting work by means of, for example, a wire electro-discharge machining in the invention, because the primary processed article is made of conductive ceramic. In particular, a wire electro-discharge machining apparatus that is available on the market is an apparatus wherein actions can be taken automatically for troubles such as breaking of a wire in the course of operation, which makes it possible to conduct completely unmanned cutting work. Therefore, in the invention, cost of cutting work and man-hours can be reduced sharply. Further, if the primary processed article is a disk as in the invention, it is possible to quarry out a member having a uniform height from the disk easily. Incidentally, since the electro-discharge machining itself is rough machining, precision work such as grinding work is conducted to form the secondary processed article which is closer in terms of a shape to the final optical element forming die.

In the conventional slicer, a cut face is inevitably flat because of the linear movement of the whetstone. However, when wire electro-discharge machining is employed by making the most of characteristics of conductive ceramic as in the invention, it is possible to perform cutting work having a higher degree of freedom such as a shape of a cylindrical surface and a shape of plane intersection with an acute angle. It is therefore possible to quarry freely despite a complicated form such as a columnar shape or a multi-prismatic shape, and arrangement of a quarried shape (for example, hexagonal closest shape) is free, which makes it possible to utilize materials effectively. Incidentally, the optical element forming die is generally in a shape of a column or a shape close to the column on the point of centering in processing, because coaxiality between the geometrical dimension reference plane transfer surface and the optical surface transfer face is strictly regulated. Therefore, if the secondary processed article is made to be in a shape of a column, it is possible to eliminate or simplify the finishing work such as rounding a corner, and to reduce scrap materials. However, when the final optical element forming die is a multi-prism, for example, a quadratic prism, if the secondary processed article is quarried from the primary processed article in a checkerboard pattern, for example, to follow the quadratic prism, the finishing work can be reduced and scrap materials can be lessened.

In the manufacturing method of the optical element forming die in Item 12, if the second process has therein a step to remove a part of the primary processed article or the secondary processed article through electro-discharge machining, it is possible to create an optical element forming die or a shape close to the optical element forming die, which is preferable.

In the manufacturing method of the optical element forming die in Item 13, it is preferable if the second process has therein a step for boring the primary processed article or the secondary processed article through electro-discharge machining. In general, the optical element forming die needs to have thereon deep holes into which a heater for heating and a thermocouple for measuring temperature are embedded, but, it has been difficult to bore such deep hole on the conventional ceramic material. However, electro-discharge machining can be applied to the primary processed article or the secondary processed article, and thereby, a deep hole can be bored promptly and easily. Boring a deep hole through mechanical machining only is practically impossible because it takes an exceedingly long time, and for example, when conventional non-conductive ceramic is used to make an optical element forming die, it is necessary to make a hole through cutting on a stage where ceramic powder is fixed by an organic binder, and to conduct sintering processing such as normal pressure sintering or HIP. However, a sintered body is deformed with its volume shrinking by 10-20% or more in the course of sintering, and thereby, a shape of the hole made in the blank material of the sintered optical element forming die is also deformed greatly. Since it is almost impossible to repair this deformation to finish to a straight hole by mechanical machining, in this case, there is no way but to use a shape of the hole thus made without taking actions on it, which is a problem. However, electro-discharge machining can be applied on the primary processed article or the secondary processed article as stated above, and thereby, processing for the deep hole can be conducted promptly and easily on a high accuracy basis. Therefore, a heater and a thermocouple mounted in holes can be brought into close contact with an inner wall of the hole with a smallest clearance, and thereby, the optical element forming die can be heated efficiently, measurement of temperature is accurate, and temperature conditions for forming an optical element can be reproduced accurately, resulting in an enhancement of the yield and stable forming.

In the manufacturing method of the optical element forming die in Item 14, it is preferable if the second process has therein a step for forming a cavity or a swelling on the primary processed article or the secondary processed article. In general, an optical surface transfer face of the optical element forming die is depressed or swelled relatively greatly, depending on a shape of an optical element, and in the case of the conventional ceramic material, it was necessary to process slowly with a shallow depth of a cut for avoiding damages of materials when machining a cavity or a swelling, and the processing has required a long time and much labors for processing. Namely, an optical surface form of an optical element which is applied, for example, to an optical pickup device is a continuous curved surface, and its diameter is as small as several mm to about 15 mm. Therefore, a spherical diamond whetstone was rotated at high speed of tens of thousands revolutions per minute to obtain a peripheral speed, and an expensive jig grinder was used to conduct basic machining for an approximate spherical form while performing NC control. In the conventional processing wherein no flexible and soft portion existed and extremely hard ceramic was machined by a hard tool in the processing machine having high stiffness, a slight error in setting and a difference of processing conditions resulted in the damage of tools and defective processed form, therefore, an operator had to be on standby for troubles, even in the case of processing for a long time. However, in the invention, there is a merit that even a relatively large cavity or swelling can be processed easily in a short period of time on an unmanned processing basis, because electro-discharge machining can be applied on the primary processed article. Incidentally, “cavity or swelling” means a shape where a cavity and a swelling exist.

In the manufacturing method of the optical element forming die in Item 15, the second process has therein a step for conducting grinding work on at least a portion where the optical element forming die is positioned. Since the electro-discharge machining is rough processing, surface roughness is sometimes inferior. Thereupon, by conducting grinding work on at least a portion where the optical element forming die is positioned, it is possible to improve dimensional accuracy for the aforesaid portion and surface roughness. With respect to the grinding work in this case, its processing time can be made as extremely short as 10-15 minutes, because a machining allowance in this case can be about 20 μm at the best. Incidentally, a portion where the optical element forming die is positioned means, for example, a plane which serves as a reference when the optical element forming die is mounted on another part, to which, however, the invention is not limited.

In the manufacturing method of the optical element forming die in Item 16, the second process has therein a step for forming a ceramic layer through CVD method on the portion which turns out to be an optical surface transfer face that forms an optical surface of the optical element, at least in the primary processed article or the secondary processed article. When forming the optical surface transfer face on the primary processed article or the secondary processed article by the use of electro-discharge machining, surface roughness is sometimes inferior because electro-discharge machining is rough processing. However, if a ceramic layer is formed through CVD method on the portion which turns out to be an optical surface transfer face of the primary processed article or the secondary processed article, as in the invention, surface roughness is sharply improved, and a mirror-finished surface onto which an optical surface of the optical element can be transferred can be obtained by conducting slight finishing processing.

The manufacturing method of the optical element forming die in Item 17 is characterized in that the primary processed article or the secondary processed article is heated by an electric current flowing through the primary processed article or the secondary processed article or by high frequency heating to form a ceramic layer. In general, there is known that rapid deposition takes place on the high temperature portion in chemical reaction in CVD method. However, in the case of indirect heating from the outside, temperature of an inner wall of a reaction vessel used in CVD method rises to the highest level in the reaction system (higher than the temperature of the primary processed article or the secondary processed article), and therefore, a thickness of a deposition layer of the primary processed article or the secondary processed article is thinner than that of the inner wall of the reaction vessel, then, effective utilization of materials cannot be achieved, frequency of cleaning of the reaction vessel for removing the deposition layer becomes high, and early damage of the reaction vessel is brought about, which is a weak point. However, when the primary processed article or the secondary processed article is conductive as in the invention, the primary processed article itself or the secondary processed article itself can be heated uniformly, because it is possible to heat through energizing or to heat by high frequency by plating electrically magnetic material such as cobalt on the surface. In this way, a temperature of the primary processed article or the secondary processed article rises to be highest in the reaction system, and deposition takes place selectively on the primary processed article or the secondary processed article, thus, materials can be utilized effectively.

In the manufacturing method of the optical element forming die in Item 18, if both of the conductive ceramic and the ceramic layer contain silicon carbide as the same material as a component, the coefficients of thermal expansion for both of them can be made the same, and thereby, scaling and cracking of a layer in the course of molding can be controlled. With regard to the optical element forming die employing the conductive ceramic of the invention, high pressure sintering (hot press) is conducted without supplying binding auxiliaries for maintaining conductivity in the course of sintering powder, and therefore, composition of the material for the molding die thus prepared includes only silicon carbide having extremely high purity and carbon, thereby, affinity of the material for the molding die with a silicon carbide layer having high purity made by CVD method is extremely high. Thus, it is possible to eliminate mostly the occurrence of scaling and cracking of a layer.

In the manufacturing method of the optical element forming die in Item 19, if the second process has therein a step to form an optical surface transfer face that forms an optical surface of an optical element by applying grinding work and/or SPDT (Single Point Diamond Turning) on the ceramic layer, it is possible to form a mirror finished surface onto which the optical surface of an optical element can be transferred.

The manufacturing method of the optical element in Item 20 is characterized in that there are provided a process to heat an optical element forming die made by using conductive ceramic having volume resistance value Z (0<Z≦1 [Ω·cm]) to the prescribed temperature by making an electric current to flow through the die and a process to press glass material heated and melted by using the heated optical element forming die, and to form an optical element. Since the conductive ceramic is used in the optical element forming die, an electric current can flow through the optical element forming die. In this case, if a temperature is raised to the prescribed value by Joule heat based on the electric current, a heater for heating the optical element forming die may be omitted, or degraded to one with smaller heat capacity. Further, since a temperature of the optical surface transfer face or the geometrical dimension reference plane transfer surface itself is raised independently of heat conducted from a heater or other members, an electric current needed for temperature rise can be small in quantity, thus, small power can be realized, and yet, temperature rise on the plane is uniform. Thus, it is possible to prevent a deformation caused by local overheating and heat expansion in the course of molding, and thereby to attain highly accurate temperature control with neither overshoot nor ringing. Further, as a condition that glass material does not stick to an optical element forming die, it is important that a temperature of the die is lower than that of the glass material, which realizes that condition accurately on an excellent reproducibility basis. In particular, when conductive silicon carbide is used, heat can be conducted easily to the whole portions because heat conductivity in this case is greater than that of other ceramics, resulting in easy uniform heating, which is preferable. Thus, an optical element which is highly accurate can be formed in the invention.

The optical element forming die unit in Item 21 is characterized in that an optical element forming die that is formed by the use of conductive ceramic having volume resistance value Z (0<Z≦1 [Ω·cm]), and has a cavity and a heating means and/or temperature measuring means arranged in the cavity of the optical element forming die are provided.

Studies of the inventors of the invention have cleared that it is possible to conduct shape forming work easily by the electro-discharge machining up to the outer shape that is close to the final finished form (near net shape), if an optical element forming die is formed by the use of conductive ceramic, and it is easy to bore a cavity such as a non-through hole on the optical element forming die. For example, when embedding a heating means such as a heater and a temperature measuring means such as a thermocouple in an optical element molding metal mold, a cavity whose depth is deep for its section, namely, a non-through hole, for example, needs to be formed, and when this cavity whose depth is deep is formed by conventional machining only, considerable time and labor are required. However, as in the invention, if an optical element forming die is formed by the use of conductive ceramic, a hole whose depth is deep can be bored by electro-discharge machining easily in a short period of time. Accuracy of an inside diameter for hole processing by the electro-discharge machining can usually be enhanced to about 10-20 μm by selecting the conditions for discharge properly. Therefore, for the hole in which a part such as the heating means or the temperature measuring means is simply inserted, sufficient fitting tolerance can be secured by only electro-discharge, thus, finishing work such as grinding work is not needed after electro-discharge machining. By forming an optical element forming die by using conductive ceramic as stated above, a cavity such as a hole through which a part is inserted in the optical element forming die can be bored easily and promptly, thus it is possible to form easily an optical element forming die unit wherein parts such as a heater for heating the optical element forming die and a thermocouple for monitoring temperatures are incorporated inside the optical element forming die in the manufacturing site where a large number of optical elements are actually formed.

Incidentally, when heating the optical element forming die, it is also conceivable to heat from the outside of the optical element forming die by an infrared radiation lamp or a revolute heater. However, the greater part of generated heat are radiated or conducted to parts surrounding the optical element forming die, and thereby, a large amount of generated heat are generally needed for heating to compensate the radiated and conducted heat. However, if a heating means such as a heater can be incorporated in a cavity of the optical element forming die, almost 100% of an amount of the generated heat can be conducted, resulting in realization of heating with excellent efficiency, and heat capacity can be small because what is heated is only the die itself, thus, control response is quick and die temperatures can be controlled on a high accuracy basis. By taking the Item of the optical element forming die of this kind, it is possible to form highly accurate optical elements on a large amount basis under the accurate temperature control, thus, the invention is epoch-making one that offers not only improvement of die materials but also highly efficient forming of optical elements which are highly accurate.

In the optical element forming die unit in Item 22, it is preferable that the cavity is formed by electro-discharge machining, but the invention is not limited to this.

Incidentally, as an optical element, there are considered a lens, a prism, a diffraction grating optical element (diffractive lens, diffractive prism, diffractive plate), an optical filter (spatial low-pass filter, wavelength band-pass filter, wavelength low-pass filter, wavelength high-pass filter), a polarizing filter (analyzer, analyzer, polarizing and separating prism), a phase filter (phase plate and hologram), to which, however, the invention is not limited.

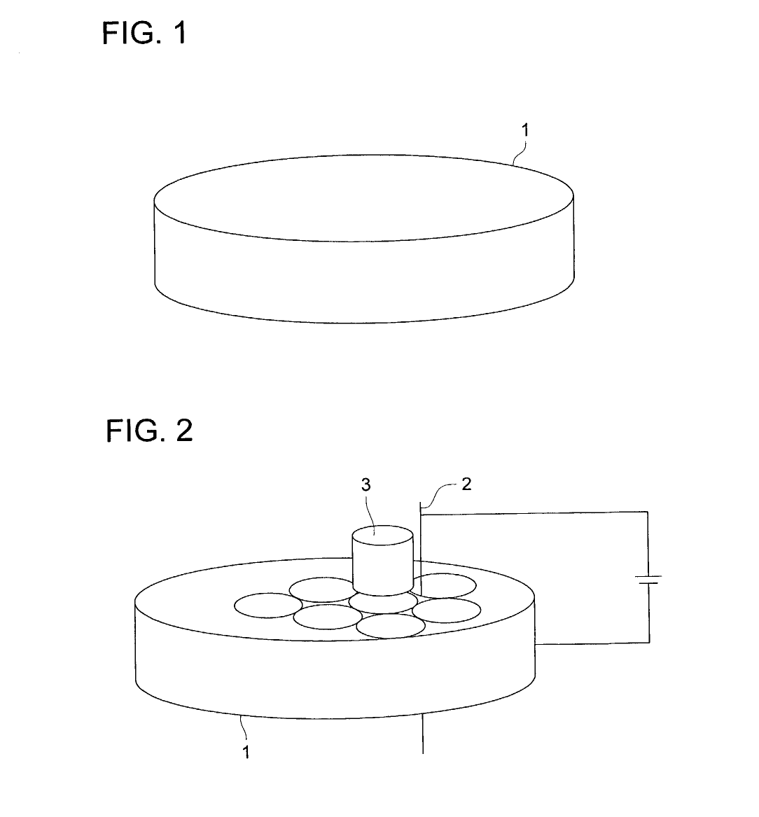

An embodiment of the invention will be explained as follows, referring to the drawings. Each of FIGS. 1-6 is a diagram showing a manufacturing process of an optical element forming die employing, for example, conductive ceramic (SiC) in dimensions of diameter 25 mm×length 25 mm. First, silicon carbide of an α type is reduced to powder, and silicon carbide of a β type is milled by CVD method. Then, when organic binders are added to the milled silicon carbide of an α type and silicon carbide of a β type to conduct high pressure sintering processing (first process), the organic binder is evaporated and primary processed article 1 of pure silicon carbide is obtained (FIG. 1). Since the first processed article 1 is a disk that has a diameter greater than that of the optical element forming die and has a uniform thickness, sintering processing for that is easy.

Further, since the first processed article 1 is conductive ceramic having volume resistance value Z (0<Z≦1 [Ω·cm], it can be subjected to electro-discharge machining. Therefore, as shown in FIG. 2, the first processed article 1 and wire 2 are connected respectively to different electrodes, and heavy-current is applied between the electrodes to conduct wire electro-discharge machining (second process). Due to this, it is possible to quarry many cylindrical die materials 3 from primary processed article 1 (cutting process), and to use the primary processed article 1 without waste.

Further, since the first processed article 1 in the present embodiment is conductive ceramic having volume resistance value of 0.015 Ω·cm], as an example, it can be subjected to electro-discharge machining. Therefore, as shown in FIG. 2, the first processed article 1 and wire 2 are connected respectively to different electrodes, and a prescribed electric current is applied between the electrodes to conduct wire electro-discharge machining (second process). Due to this, it is possible to quarry many cylindrical die materials 3 from primary processed article 1 (cutting process), and to use the primary processed article 1 without waste. Incidentally, in an example, it was possible to quarry one die material 3 in 30 minutes through the wire electro-discharge machining, and to keep the accuracy for an outside diameter to be 20 μm or less. In the example of this kind, surface roughness was about Ra0.5 μm. When conducting grinding work by the use of an expensive tool such as a diamond whetstone for enhancing the outside diameter accuracy more afterward, the surface roughness stated above makes wear and deterioration of tools to be minimum.

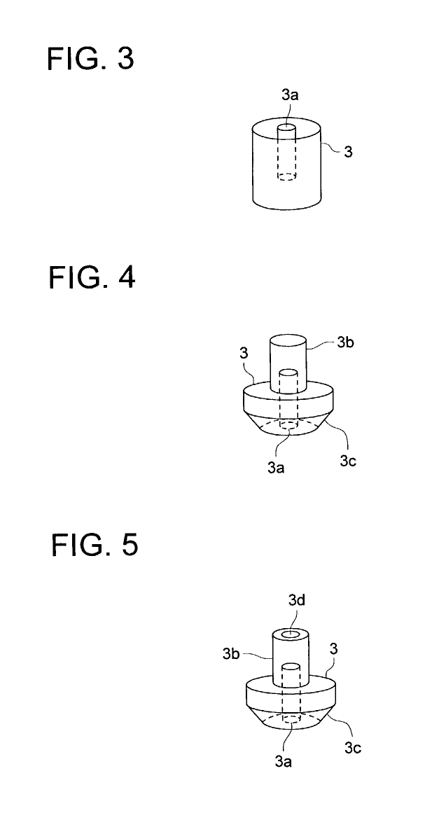

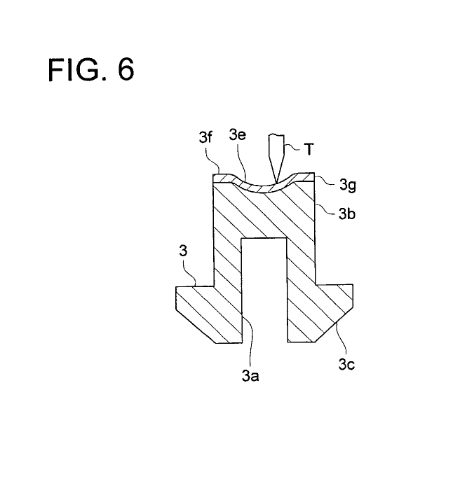

Then, as shown in FIG. 3, electro-discharge machining is applied at the center on the end face of die material 3 to bore hole 3a (boring process). In an example, when electro-discharge machining was conducted to bore hole (cavity) 3a having inside diameter 12 mm×depth 20 mm by the use of a copper cylindrical electrode, the working time was 20 minutes and a dimensional error of a hole diameter was 15 μm. This means that the working time for the electro-discharge machining was one tenth of working time for the conventional mechanical machining. Incidentally, machining of the hole 3a may be performed at any time within a period up to the processing shown in FIG. 6, without being limited to the aforesaid moment. Further, the die material 3 shown in FIG. 3 is turned upside down, and a diameter of an upper portion in FIG. 4 is reduced by electro-discharge machining to form diameter-reduced portion 3b, and tapered surface 3c is formed by cutting a circumference of the bottom end in FIG. 4. After that, grinding processing is applied on an outer circumferential surface of die material 3 (an outer circumferential surface of diameter-reduced portion 3b including tapered surface 3c).

Further, as shown in FIG. 5, cavity (or swelling) 3d is formed at the center of the end face of diameter-reduced portion 3b through electro-discharge machining. In this case, grinding processing may also be applied on the inside of the cavity 3d thus formed or on its peripheral surface. After that, silicon carbide layer 3g is formed on the end face of diameter-reduced portion 3b through CVD processing as shown in FIG. 6 (layer forming process). Its thickness is preferably 0.1-4 mm. Furthermore, SPDT processing and grinding processing by diamond tool T are conducted to form, on the layer 3g on the cavity 3d, optical surface transfer face 3e that corresponds to an optical surface of an optical element to be formed (process to form an optical surface transfer face), and to form, on the circumference of the optical surface transfer face 3e, geometrical dimension reference plane transfer surface 3f that corresponds to the geometrical dimension reference plane of an optical element to be formed. After that, the optical surface transfer face 3e and the geometrical dimension reference plane transfer surface 3f are covered by a protective layer made of diamond-like carbon.

Finally, optical element forming die 3′ is completed. Incidentally, as a finishing work, electric plating processing is also considered in addition to grinding work. Processes shown in FIG. 3-FIG. 6 are included in the second process.

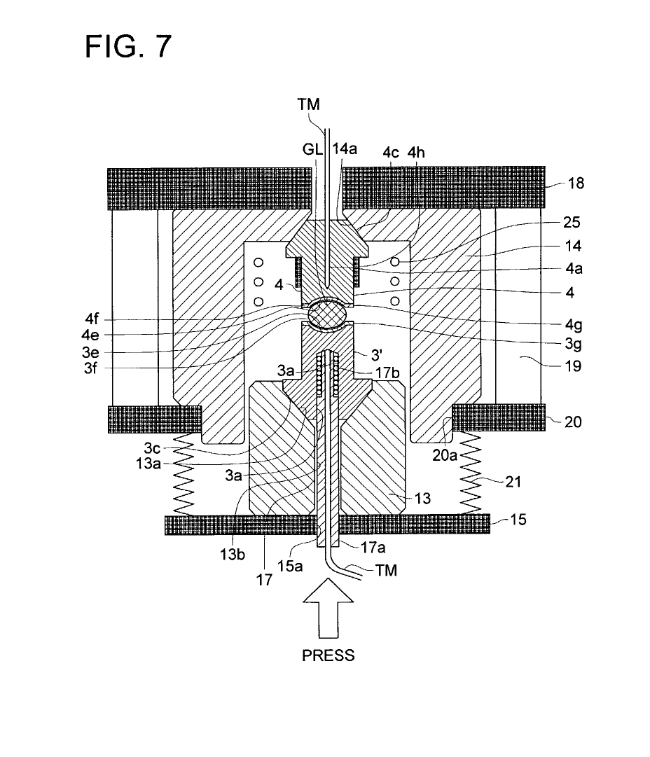

FIG. 7 is a sectional view of a die set including an optical element forming die for molding an optical element. Optical element forming die 3′ formed in the aforesaid way and optical element forming die 4 formed in the same way as in the foregoing are inserted so that optical surface transfer face 3e and geometrical dimension reference plane transfer surface 3f may face respectively optical surface transfer face 4e and geometrical dimension reference plane transfer surface 4f, and so that their tapered surfaces 3c and 4c may come in contact respectively with tapered surface 13a of lower die holder 13 in a corresponding shape and tapered surface 14a of upper die holder 14. Incidentally, the optical element forming die 4 is fixed on the upper holder 14 by an unillustrated supporting member so that the optical element forming die 4 may not fall by gravity.

The lower die holder 13 that is preferable if it is made of heat insulating material is mounted on the top face of laminar movable platen 15 to be movable integrally. The movable platen 15 can move in the optical axis direction, owing to an unillustrated guide mechanism, while making an optical axis of the optical surface transfer face 3e to agree with that of the optical surface transfer face 4e.

The upper die holder 14 that is preferable if it is made of heat insulating material is mounted on upper die platen 18 with the top face of the upper die holder touching the upper die platen 18, and the lower end of the upper die holder 14 is fitted with opening 20a of disk-shaped holding plate 20 that is fixed on stay 19 extending downward from the upper die platen. There is arranged airtight bellows 21 between an outer edge on the top face of the movable platen 15 and surroundings of the opening 20a on the bottom surface of the holding plate 20. The airtight bellows expands and contracts together with a movement of the movable platen 15, and when the surroundings of the optical element forming dies 3′ and 4 are made to be of a vacuum atmosphere or a nitrogen gas atmosphere, the airtight bellows isolates this atmosphere from the air.

In the example shown in FIG. 7, an inside diameter of hole 3a of the lower optical element forming die 3′ is greater than that of hole 4a of the optical element forming die 4. In the hole 3a, there is inserted heater unit 17 wherein thermocouple TM serving as a temperature measuring means is covered by heat insulating sheath 17a made of heat insulating ceramic having high machinability, and heater 17b serving as a heating means is wound round the outer circumference of the tip of the thermocouple. The heat insulating sheath 17a prevents the thermocouple TM from being heated directly by infrared rays radiated from the heater 17b. The heater unit 17 passes through central opening 13b of the lower die holder 13 and opening 15a of the movable platen 15 to extend to the outside on the lower portion. The optical element forming die 3′ and heating unit 17 constitute an optical element forming die unit.

As an example, 90 W heater 17b with sheath diameter of 1 mm was wound doubly round the heat insulating sheath 17a in a coil form to make an outside diameter to be 10 mm, and K thermocouple TM with sheath diameter 1 mm was inserted in the center hole having an inside diameter of 1.2 mm of the heat insulating sheath 17a. The thermocouple TM was arranged so that its tip may touch the bottom of hole 3a at the position of 2 mm from optical surface transfer face 3e of the optical element forming die 3′, and when the optical element forming die 3′ was heated by controlling an electric current of heater 17b with a value of measured temperature of the thermocouple TM, about 35 seconds were required for the temperature of the optical surface transfer face 3e to rise from a room temperature to 500° C. When the temperature was kept to be constant at 500° C., temperature fluctuation of the thermocouple TM inside the optical element forming die 3′ was ±1° C. or less, and temperature fluctuation of the optical surface transfer face 3e was ±0.2° C. A temperature difference between the inside of the die and the optical surface transfer face 3e was about 30° C. and it was constant independently of temperature rising, temperature falling and a fixed temperature. Therefore, it was found that the heat loss to parts other than the optical element forming die 3′ was less and almost constant (established temperature value—30° C.), and it was possible to grasp the actual temperature of the optical surface transfer face 3e accurately. Electric power required for heating was 90 W for heating for 35 seconds from a room temperature to 500° C., and that for keeping at fixed temperature of 500° C. was 17 W. These values of electric power are about ⅕-1/10 of the electric power required for the occasion to obtain the same heating time as in the method to heat from the outside of the conventional optical element forming die.

On the other hand, thermocouple TM only is inserted in the hole 4a of the upper optical element forming die 4. Instead, an outer circumferential surface of the optical element forming die 4 is covered with nickel plating 4h. Further, the optical element forming die 4 is surrounded by high frequency induction coil 25. When the high frequency induction coil 25 is energized, the nickel plating 4h is heated, and thereby, the optical element forming die 4 is heated. The optical element forming die 4 and thermocouple TM constitute an optical element forming die unit. If an inner circumferential surface of the hole 4a is covered by nickel plating 4h, the optical element forming die 4 can be heated from its inside. The Item for heating the optical element forming dies 3′ and 4 is not limited to the aforementioned embodiment, and they may be replaced each other, they may be the same or they may be those different from the foregoing.

In the course of molding, heated and melted glass material GL is inserted in a space between the optical element forming dies 3′ and 4, while measuring temperatures with thermocouple TM inserted in the hole 3a of the optical element forming dies 3′ and with thermocouple TM inserted in the hole 4a of the optical element forming die 4, then, the glass material is pressed when movable platen 15 is moved upward by an unillustrated press member, and is cooled, thus, an optical element in the desired form can be obtained. Tapered surfaces 13a and 14a prevent decentering and tilt of the die by determining the positioning including centering of optical element forming die 3′ in the course of pressing.

When the protective layers for covering optical surface transfer face 3e and geometrical dimension reference plane transfer surface 3f peel off gradually as the frequency of molding optical elements increases, if the optical element forming die 3′ is taken out and is heated, the protective layer dissipates. Therefore, by providing the protective layer newly, the same optical element forming die 3′ can be used for a long time. In that case, the optical element forming die 3′ can be disassembled easily, because it is not fixed on the lower die holder 13 by the use of bolts but is in contact through tapered surfaces 3c and 13a alone.

The invention makes it possible to provide an optical element forming die in which processing is easy and cost is low despite ceramic materials used, a manufacturing method of the optical element forming die, a manufacturing method of an optical element and an optical element forming die unit.

What is claimed is:

1. A method of producing an optical element forming die to form an optical element by pressing a glass material softened with heat, comprising:
a first process of producing a primary processed product having a volume resistance value Z (0<Z≦1 (Ω·cm)) by sintering ceramic powders; and
a second process of forming the optical element forming die by processing the primary processed product.

2. The method of claim 1, wherein in the first process, the primary processed product is produced in a shape of a plate by a hot press method.

3. The method of claim 1, wherein the second process comprises a process to subdivide the primary processed product by an electro-discharge machining into a predetermined size so as to produce a secondary processed product.

4. The method of claim 3, wherein the second process comprises a process to remove a part of the primary processed product or the secondary processed product by an electro-discharge machining.

5. The method of claim 3, wherein the second process comprises a process to make a hole on the primary processed product or the secondary processed product.

6. The method of claim 3, wherein the second process comprises a process to make a concave or a protrusion on the primary processed product or the secondary processed product.

7. The method of claim 3, wherein the second process comprises a process to conduct a grinding process for at least a portion used for positioning the optical element forming die.

8. The method of claim 7, wherein the second process comprises a process to form a ceramic layer by a CVD method at least on a portion of the primary processed product or the secondary processed product which becomes an optical surface transferring surface to form an optical surface of the optical element.

9. The method of claim 8, wherein in the process to form the ceramic layer by the CVD method, the ceramic layer is formed by heating the primary processed product or the secondary processed product by electrically energizing or by a high frequency wave heating.

10. The method of claim 8, wherein the conductive ceramic and the ceramic layer contain silicon carbide as a composition.

11. The method of claim 8, wherein the second process comprises a process to form an optical surface transferring surface to form an optical surface of the optical element by conducting a grinding process and/or a SPDT process for the ceramic layer.

12. An optical element forming die unit, comprising:
an optical element forming die formed by using a conductive ceramic having a volume resistance value Z (0<Z≦1 (Ω·cm)) and having a concave portion; and
a heating member and/or a temperature measuring member which are provided in the concave portion of the optical element forming die.

13. The optical element forming die unit of claim 12, wherein the concave portion is formed by an electro-discharge machining.

14. An optical element forming die to form an optical element by pressing a glass material softened with heat, comprising:
at least a part of the optical element forming die formed by using a conductive ceramic, wherein the volume resistance value Z of the conductive ceramic satisfies the following formula:
0<Z≦1 (Ω·cm)

15. The optical element forming die of claim 14, further comprising:
a surface to press the optical element forming die has a tapered surface, wherein positioning for the optical element forming die when an optical element is formed is conducted by pressing the tapered surface.

16. The optical element forming die of claim 14, further comprising an optical surface transferring surface to form an optical surface of the optical element and a geometrical dimension reference surface transferring surface to form a geometrical dimension reference surface of the optical element, wherein a ceramic layer is formed on at least one of the optical surface transferring surface and the geometrical dimension reference surface transferring surface by a CVD method.

17. The optical element forming die of claim 16, wherein the conductive ceramic and the ceramic layer contain silicon carbide as a composition.

18. The optical element forming die of claim 16, wherein the ceramic layer formed on the at least one of the optical surface transferring surface and the geometrical dimension reference surface transferring surface of the optical element forming die is covered with a protective layer to prevent fusion adhesion of a glass and/or oxidation of the optical element forming die.

19. The optical element forming die of claim 18, wherein the protective layer is a single layer or multi layers formed by at least one material selected from a group consisting of carbon, diamond-like carbon, glass-like carbon, platinum alloy, titanium, titanium carbide, titanium nitride, chromium, chromium carbide, chromium nitride, boron nitride, silicon carbide and silicon nitride.

20. The optical element forming die of claim 14, wherein the temperature of the optical element forming die is raised to a prescribed temperature by electrically energizing the optical element forming die.

21. The optical element forming die of claim 14, wherein the optical element forming die is subjected to an electric plating treatment.
